(19) United States
(12) Patent Application Publication
(10) Pub. No.: US 2017/0153696 A1
(43) Pub. Date: Jun. 1, 2017

(54) METHOD AND SYSTEM FOR ASSOCIATION OF BIOMETRIC SENSOR DATA WITH DYNAMIC ACTIONS

(71) Applicant: INTERNATIOANAL BUSINESS MACHINES CORPORATION, ARMONK, NY (US)

(72) Inventors: David Jaramillo, Lake Worth, FL (US); Richard Newhook, Raleigh, NC (US); Viney A. Ugave, Delray Beach, FL (US)

(21) Appl. No.: 14/953,495

(22) Filed: Nov. 30, 2015

(51) Int. Cl. G06F 3/01; G06F 21/32; G06F 3/0484

(52) U.S. Cl. CPC G06F 3/011; G06F 3/0484; G06F 21/32

(57) ABSTRACT

A method of operating an electronic device includes: receiving, at the electronic device, a first biometric input from a first user; matching, at the electronic device, the first biometric input to a first biometric profile of the user, wherein the first biometric profile is stored in a biometric database on the electronic device, the biometric database including a plurality of biometric profiles for the first user, each biometric profile being associated with an action; and performing, at the portable device, a first action corresponding to the first biometric profile of the first user.

### 1. TECHNICAL FIELD

The present invention relates to biometric sensing including authentication as well as other functions, and more particularly, to biometrics on a mobile device.

### 2. DISCUSSION OF THE RELATED ART

Biometric based sensor authentication has become mainstream, especially with the introduction of biometric sensors on mobile devices like the smartphone. Biometric sensors can be a ubiquitous technology like a microphone for voice capture or a high definition camera for facial recognition. They can also be specially designed units made to scan the vein patterns under your skin or the unique features in your fingertip. Biometric sensors are an essential aspect of identity technology. However, these sensors can serve multiple purposes and can be used for more than just identification.

A mobile app is a computer program designed to run on mobile devices such as a smartphone and a tablet computer. Application launch on a smartphone is limited to pressing a few hardware buttons or touching a particular area on the smartphone's touchscreen. A touchscreen is an input device normally layered on the top of an electronic visual display of an information processing system. These touches could be from your finger, a stylus, etc. However, to the touchscreen, these touches are indistinguishable.

Users are able to search for desired apps by typing in or browsing through the mobile device and tapping the appropriate icon. A few apps like the camera, which are frequently used, can be launched using dedicated hardware buttons. However, due to the complexity of functions in a mobile device, the number of apps that are frequently used is large. Thus, a dedicated hardware button for each of these actions (e.g., search, launch, etc.) cannot be provided. Further, the addition of extra steps to complete such actions would inconvenience certain users.

### BRIEF SUMMARY

In an exemplary embodiment of the present invention, there is provided a method of operating an electronic device comprising: receiving, at the electronic device, a first biometric input from a first user; matching, at the electronic device, the first biometric input to a first biometric profile of the user, wherein the first biometric profile is stored in a biometric database on the electronic device, the biometric database including a plurality of biometric profiles for the first user, each biometric profile being associated with an action; and performing, at the portable device, a first action corresponding to the first biometric profile of the first user.

The electronic device includes a smartphone or a tablet computer.

The first biometric input includes a fingerprint scan, an iris scan, a retina scan, an ear scan, a face scan or spoken language.

The plurality of biometric profiles for the first user include a first plurality of biometric profiles for biometric inputs of a first type, each of the first plurality of biometric profiles being associated with an action of a first context.

Each of the first plurality of biometric profiles for the first user are associated with an action of a second context.

The plurality of biometric profiles for the first user include a second plurality of biometric profiles for biometric inputs of a second type, each of the second plurality of biometric profiles being associated with an action of the first context.

The plurality of biometric profiles for the first user include a second plurality of biometric profiles for biometric inputs of a second type, each of the second plurality of biometric profiles being associated with an action of a first context.

The first action includes opening a software application or performing a step in a software application that is already open.

The biometric database is built by interaction between the user and the electronic device.

In an exemplary embodiment of the present invention, there is provided a method of biometric association between user input and electronic device actions comprising: receiving, at an electronic device, a first biometric input from a first person; associating, at the electronic device, a first action to the first biometric input; storing, at the electronic device, the first biometric input and the first action in a biometric database; receiving, at the electronic device, a second biometric input from the first person; associating, at the electronic device, a second action to the second biometric input; and storing, at the electronic device, the second biometric input and the second action in the biometric database, wherein when the first biometric input is received again at the electronic device, the first action is automatically performed and when the second biometric input is received again the electronic device, the second action is automatically performed.

When the first biometric input is received again at the electronic device, the first biometric input is authenticated using the first biometric input stored in the biometric database, and when the second biometric input is received again at the electronic device, the second biometric input is authenticated using the second biometric input stored in the biometric database.

The first biometric input corresponds to a first body part and the second biometric input corresponds to a different body part

The first action is associated to the first biometric input by a user, and the second action is associated to the second biometric input by the user.

The first or second actions include application launch, a custom function, or an action within an application.

The electronic device is a mobile device.

In an exemplary embodiment of the present invention, there is provided an electronic device comprising: a plurality of biometric sensors, wherein each sensor is configured to read a different biometric signature; a storage device, wherein the storage device is configured to store a plurality of biometric signatures and their associated actions; and a processing device, wherein when a first biometric signature is received at the electronic device, the processing device is configured to match the first biometric signature to a first biometric profile stored in the storage device and execute software corresponding to the first action.

The electronic device includes a smartphone or a tablet computer.

The software corresponding to the first action includes an application run by an operating system of the smartphone or tablet computer.

The biometric sensors include physiological characteristic sensors.

The biometric sensors include behavioral characteristics sensors.

### BRIEF DESCRIPTION OF THE SEVERAL VIEWS OF THE DRAWINGS

FIG. 1 is a flowchart of a setup stage in which biometric profiles are associated with actions according to an exemplary embodiment of the present invention;

FIG. 2 is a flowchart of a usage stage in which actions are performed in response to biometric inputs according to an exemplary embodiment of the present invention; and

FIG. 3 illustrates an apparatus for implementing an exemplary embodiment of the present invention.

### DETAILED DESCRIPTION

Biometric sensors have the ability to detect a person based on physiological or behavioral characteristics. For example, fingerprint scanners get an image of your fingerprint and match it with pre-scanned images to determine if it is the same person. When using a fingerprint scanner, it is possible to store multiple fingerprints of the same hand and determine which finger was used for a particular scan. In addition, it is possible to record alternative data relating to biometric sensors, such as the rotation of the fingerprint, or partial prints.

In accordance with an exemplary embodiment of the present invention, such biometric samples are used to create biometric-related profiles which are then associated with individual actions.

For example, the fingerprint pattern for every finger of an individual is unique and distinctive. This way, there can be multiple profiles for an individual for every finger on the hands. The aforementioned can also be combined with other existing device elements, such as hardware buttons or the touchscreen, further increasing the combinations and flexibility available for associating a biometric profile with a custom action.

In accordance with an exemplary embodiment of the present invention, there are two stages, namely the setup stage and the usage stage. Briefly, in the setup stage, the user scans the biometric samples, e.g., each finger on his hand, to be stored in a biometric database. Then, the user assigns an action to each finger. In the usage stage, the user just scans the finger of his choice and the system matches it to the biometric database and performs the custom action associated with the biometric profile like a single finger.

Exemplary embodiments of the present invention will be described in detail hereinafter with reference to the accompanying drawings.

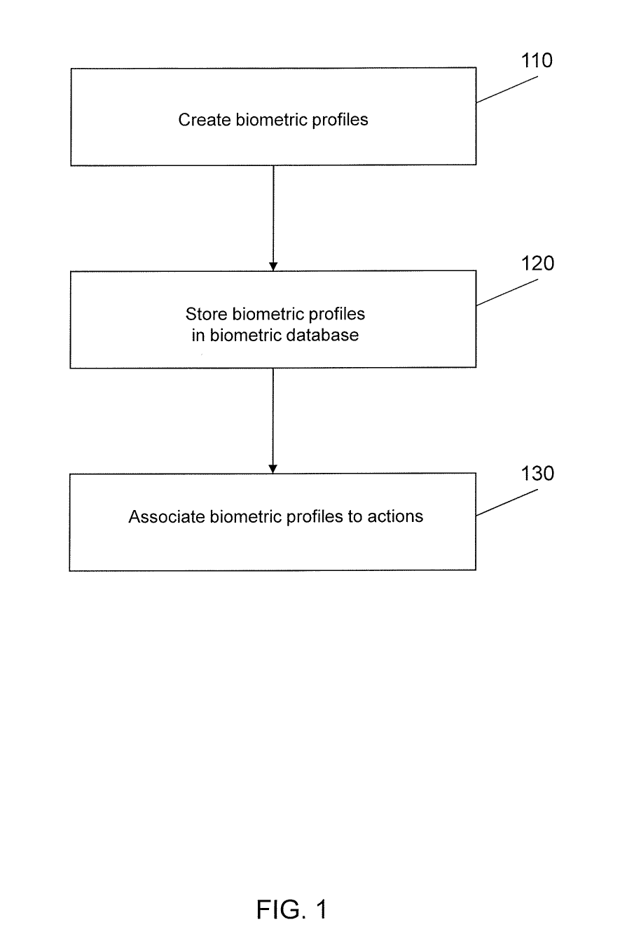

FIG. 1 is a flowchart of a setup stage in which biometric profiles are associated with actions according to an exemplary embodiment of the present invention.

In the following discussion, a smartphone will be described as an exemplary mobile electronic device. It is to be understood, however, that a variety of mobile electronic devices, e.g., a tablet computer, and non-mobile electronic devices, e.g., a stationary computer, can be used in accordance with an exemplary embodiment of the present invention.

As an example, a mobile device is a small computing device, typically small enough to be handheld having a display screen with a touch input and/or a miniature keyboard. Such a handheld computing device can have an operating system, and can run various types of application software, known as apps. Most handheld devices can also be equipped with wireless fidelity (Wi-Fi), Bluetooth, near field communication (NFC) and global positioning system (GPS) capabilities that allow connection to the internet and other devices, such as an automobile or a microphone headset or can be used to provide location-based services.

In addition, in the following discussion, fingerprints will be described as an exemplary biometric input. It is to be understood, however, that a variety of biometric inputs can be used in accordance with an exemplary embodiment of the present invention. Examples include, but are not limited to palm veins, face, DNA, palm print, hand geometry, iris, retina, odor/scent. In addition to the aforementioned physiological characteristics, behavioral characteristics, including but not limited to typing rhythm, gait and voice, can be used in accordance with an exemplary embodiment of the present invention.

Referring now to FIG. 1, biometric profiles are created (110). In this step, a user can scan in the fingerprint of his right hand thumb. This scanning process can occur at the smartphone itself when the smartphone is equipped with a fingerprint scanner. At this time, the user may scan in the rest of the fingerprints of his right hand. He could also scan in the fingerprints of this left hand. All of these scans are then stored in a biometric database on the phone (120).

In the case the user does not want to scan in his fingerprints, he could choose to scan his face with the phone's camera or build a database of vocal samples with the phone. In addition, if the user's fingerprints are already stored somewhere else (say on another smartphone), they can be wirelessly provided from that phone to the biometric database being created on the instant phone.

With the database now built such that, for example, each fingerprint has an individual profile associated therewith, the user may then begin to manually assign actions to the profiles (130). For example, the user may chose assign the action of launching an application to the profile of his right hand thumb. For example, the user's right hand thumb may then be used to open an application like facebook or the phone's camera. As another example, the user may assign the action of launching another application to the profile of his right hand index finger.

It is to be understood, that although the database is being described as including profiles and corresponding actions for the user's fingerprints, the database can also include profiles and corresponding actions for other biometric signatures of the user. For example, when the phone is equipped with an iris scanner, the profile of the user's right eye can be associated with the action of moving a page to the right when in a browser app. As another iris example, the profile of the user's right eye can be associated with the action of ‘liking’ a photograph when in facebook.

In another example, when the phone is equipped with voice recognition software, the profile of the user's loud voice can be associated with the action of increasing the phone's speaker volume. The profile of the user's loud voice can also be associated with the action of showing the user's heart rate, when in a health app. In yet another example, when the phone is equipped with an ear scanner, the profile of the user's left ear can be associated with the action of accepting a phone call when in a phone app, and the profile of the user's right ear can be associated with the action of rejecting a phone call when in the phone app.

As can be seen, the individual profile of the user's right hand thumb can be associated with more than one action. This may be referred to as context based association. In other words, when the phone is in the camera app, the user's right hand thumb profile may be associated with the action of taking a photograph. When the phone is in a banking app, the user's right hand thumb profile may be associated with the action of transferring funds from one account to another.

The following table is an example showing that each finger of the right hand of a user can be associated with several different actions, depending on context.

| User's | Context 1 | Context 2 | Context 3 |
|---|---|---|---|
| right hand profile | action | action | action |
| Thumb | T1 | T2 | T3 |
| Index | I1 | I2 | I3 |
| Middle | M1 | M2 | M3 |
| Ring | R1 | R2 | R3 |
| Pinky | P1 | P2 | P3 |

The information shown in the above table can be stored in the database. Further, the biometric profiles and corresponding actions of plural users can be stored in the database. Moreover, the user's right hand thumb profile can have a sub-profile and corresponding action that are stored in the database. For example, a combination of the thumbprint and a particular application pressure may have its own profile and a unique action associated therewith. As another example, a combination of the index fingerprint and an elevated skin temperature reading may have its own profile and a unique action associated therewith. Further, the combination of an eye scan and a fingerprint may have its own profile and a unique action associated therewith. Moreover, the combination of a thumbprint and the depressing of a device button may its own profile and a unique action associated therewith.

As can be seen, the use of the biometric profile-to-action association with other existing device elements, such as hardware buttons or the touchscreen, further increases the combinations and flexibility available for associating a biometric profile with a custom action.

In step 130, it is to be understood that system software operating on the phone may be used to provide the user with suggestions for associating actions to particular profiles. This may occur in the case, when the phone has learned the habits of the user and knows which fingers are used to effectuate certain tasks.

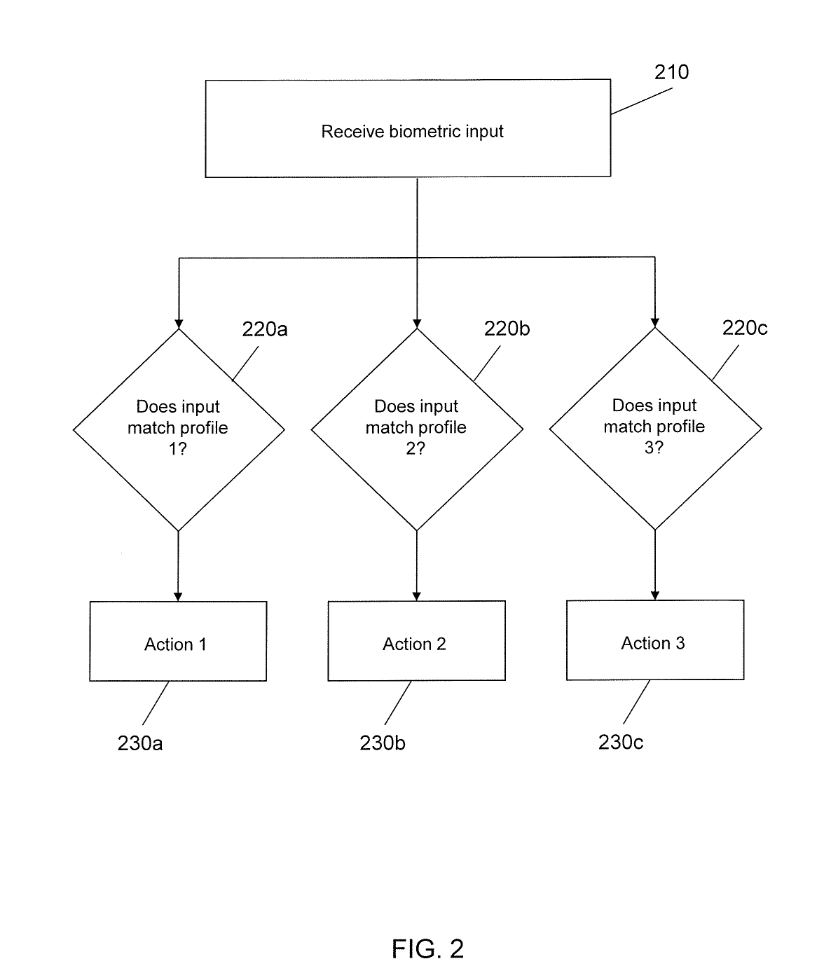

FIG. 2 is a flowchart of a usage stage in which actions are performed in response to biometric inputs according to an exemplary embodiment of the present invention.

For example, when a user is operating his smartphone, he may desire to view photos on his camera. Therefore, he may need to launch his phone app. To do this, he may simply tap his left index finger on the phone's touchscreen (210). A scan of this left index fingerprint will be taken and matched to a profile stored in the biometric database.

For example, the fingerprint will be checked to see if it matches profile 1 (220a), profile 2 (220b), or profile 3 (220c). It is to be understood that the number of profiles the acquired fingerprint is compared to in this example is merely exemplary. In practice, there may be many more profiles for comparison. If the fingerprint matches profile 1, action 1 will be performed at the phone (230a). If the fingerprint matches profile 2, action 2 will be performed at the phone (230a). If the fingerprint matches profile 3, action 3 will be performed at the phone (230a). Assuming, for example, the fingerprint matches profile 1 and that action 1 corresponds to the launch of the phone's camera app, the phone's camera app will be launched substantially immediately in response to user touching the touchscreen with his left index finger.

As can be seen, the inventive concept described herein dynamically assigns actions to a biometric signature (e.g., fingerprint, voice, retina scan, etc.) and invokes those actions when that biometric signature is detected.

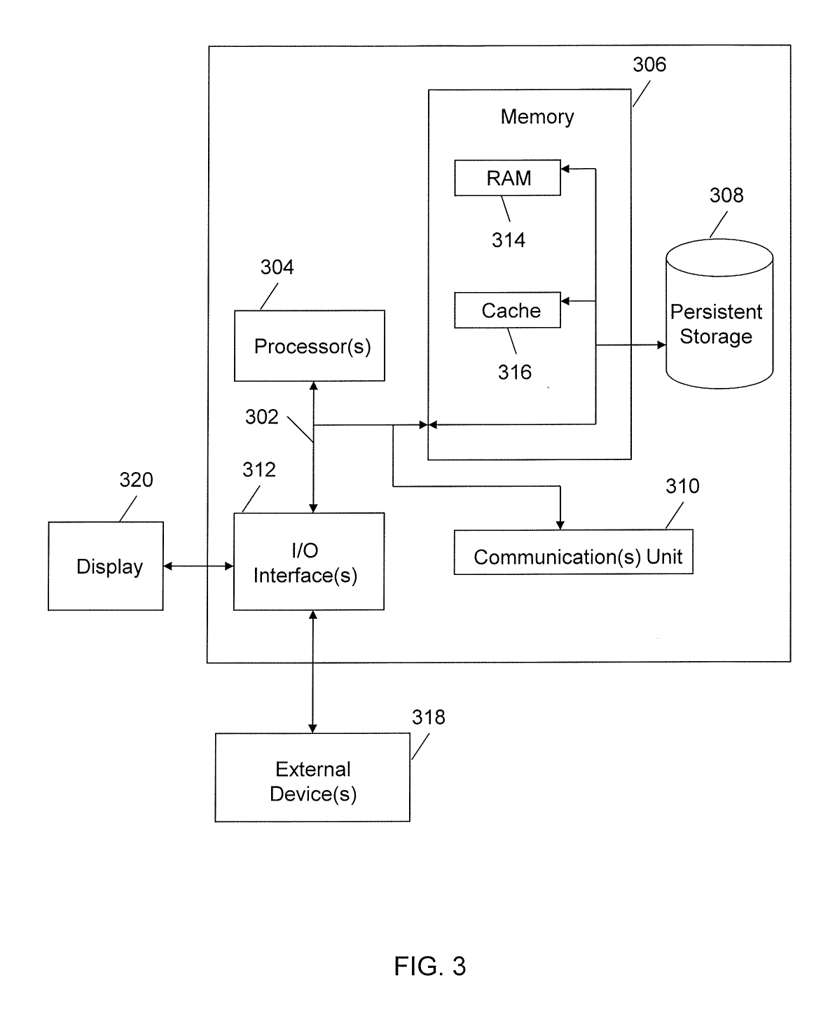

FIG. 3 depicts a block diagram of components of a computer on which the biometric database is stored or an electronic device (e.g., a smartphone or a tablet computer), in accordance with an exemplary embodiment of the present invention. It should be appreciated that FIG. 3 provides only an illustration of one implementation, and does not imply any limitations with regard to the environments in which different embodiments may be implemented. Many modifications to the depicted environment may be made.

The computer on which the biometric database is stored or the electronic device can include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

The biometric database may be stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 may include one or more network interface cards. Communications unit 310 may provide communications through the use of either or both physical and wireless communications links. Information from social networks may be downloaded to persistent storage 308 through communications unit 310.

I/O interface(s) 312 allows for input and output of data with other devices that may be connected to the computer on which the biometrics database is stored or the electronic device. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., supervised machine learning algorithms, can be stored on such portable computer readable storage media and can be loaded onto persistent storage 308 via I/O interface(s) 312. I/O interface(s) 312 also connect to a display 320. Display 320 provides a mechanism to display data to a user and may be, for example, a computer monitor or an incorporated display screen, such as is used in tablet computers and smart phones.

The electronic device in accordance with an exemplary embodiment of the present invention may include an advanced mobile operating system which combines features of a personal computer operating system with other features useful for mobile or handheld use. For example, the electronic device may combine the features of a cell phone with those of other mobile devices, such as a personal digital assistant (PDA), a media player and a global positioning system (GPS) navigation unit.

The electronic device in accordance with an exemplary embodiment of the present invention may include a radio frequency (RF) transceiver module to connect the electronic device to the internet via a cellular network, or a WiFi/802.11 module to connect the electronic device to the internet via a wireless local area network (WLAN).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of operating an electronic device, comprising:
receiving, at the electronic device, a first biometric input from a first user;
matching, at the electronic device, the first biometric input to a first biometric profile of the user, wherein the first biometric profile is stored in a biometric database on the electronic device, the biometric database including a plurality of biometric profiles for the first user, each biometric profile being associated with an action; and
performing, at the portable device, a first action corresponding to the first biometric profile of the first user.

2. The method of claim 1, wherein the electronic device includes a smartphone or a tablet computer.

3. The method of claim 1, wherein the first biometric input includes a fingerprint scan, an iris scan, a retina scan, an ear scan, a face scan or spoken language.

4. The method of claim 1, wherein the plurality of biometric profiles for the first user include a first plurality of biometric profiles for biometric inputs of a first type, each of the first plurality of biometric profiles being associated with an action of a first context.

5. The method of claim 4, wherein each of the first plurality of biometric profiles for the first user are associated with an action of a second context.

6. The method of claim 4, wherein the plurality of biometric profiles for the first user include a second plurality of biometric profiles for biometric inputs of a second type, each of the second plurality of biometric profiles being associated with an action of the first context.

7. The method of claim 4, wherein the plurality of biometric profiles for the first user include a second plurality of biometric profiles for biometric inputs of a second type, each of the second plurality of biometric profiles being associated with an action of a first context.

8. The method of claim 1, wherein the first action includes opening a software application or performing a step in a software application that is already open.

9. The method of claim 1, wherein the biometric database is built by interaction between the user and the electronic device.

10. A method of biometric association between user input and electronic device actions, comprising:
receiving, at an electronic device, a first biometric input from a first person;
associating, at the electronic device, a first action to the first biometric input;
storing, at the electronic device, the first biometric input and the first action in a biometric database;
receiving, at the electronic device, a second biometric input from the first person;
associating, at the electronic device, a second action to the second biometric input; and
storing, at the electronic device, the second biometric input and the second action in the biometric database,
wherein when the first biometric input is received again at the electronic device, the first action is automatically performed and when the second biometric input is received again the electronic device, the second action is automatically performed.

11. The method of claim 10, wherein when the first biometric input is received again at the electronic device, the first biometric input is authenticated using the first biometric input stored in the biometric database, and when the second biometric input is received again at the electronic device, the second biometric input is authenticated using the second biometric input stored in the biometric database.

12. The method of claim 10, wherein the first biometric input corresponds to a first body part and the second biometric input corresponds to a different body part

13. The method of claim 10, wherein the first action is associated to the first biometric input by a user, and the second action is associated to the second biometric input by the user.

14. The method of claim 10, wherein the first or second actions include application launch, a custom function, or an action within an application.

15. The method of claim 10, wherein the electronic device is a mobile device.

16. An electronic device, comprising:
a plurality of biometric sensors, wherein each sensor is configured to read a different biometric signature;
a storage device, wherein the storage device is configured to store a plurality of biometric signatures and their associated actions; and
a processing device, wherein when a first biometric signature is received at the electronic device, the processing device is configured to match the first biometric signature to a first biometric profile stored in the storage device and execute software corresponding to the first action.

17. The electronic device of claim 16, wherein the electronic device includes a smartphone or a tablet computer.

18. The electronic device of claim 17, wherein the software corresponding to the first action includes an application run by an operating system of the smartphone or tablet computer.

19. The electronic device of claim 16, wherein the biometric sensors include physiological characteristic sensors.

20. The electronic device of claim 16, wherein the biometric sensors include behavioral characteristics sensors.
